(19) United States
(12) Patent Application Publication
(10) Pub. No.: US 2011/0297594 A1
(43) Pub. Date: Dec. 8, 2011

(54) APPARATUS FOR GENERATING HIGH-FREQUENCY ELECTROMANETIC FIELD WITH ADJUSTABLE MAGNETIC FIELD INTENSITY AND WAVEFORM AND WATER PURIFICATION SYSTEM COMPRISING THE SAME

(75) Inventor: Byonggi Lee, Paju (KR)

(73) Assignees: Byongkwan Lee, Paju (KR); CHUNG HAE ENVRIONMENT CO., LTD, Paju (KR); Byonggi Lee, Paju (KR)

(21) Appl. No.: 13/150,730

(22) Filed: Jun. 1, 2011

(30) Foreign Application Priority Data
Jun. 4, 2010 (KR) 10-2010-0052633

(51) Int. Cl. C02F 1/46; H02K 19/16

(52) U.S. Cl. 210/150; 290/1 R

(57) ABSTRACT

The present invention relates to an apparatus for generating high frequency electromagnetic field with adjustable magnetic field intensity and waveform and water purification system comprising the same. The apparatus for generating high frequency electromagnetic field is comprising of a user input unit into where the user can input; a quantum field generator for generating a quantum field of high voltage which is capable of adjusting output voltage; a wave generator for generating high-frequency signals of variable waveforms and matching with the quantum field; a high-frequency output unit for scanning the matched quantum field of high frequency; and a controller that controls magnitude of output voltage from the quantum field generator and output frequency from the wave generator. Therefore, the present invention provides the apparatus for generating high frequency electromagnetic field with extra high voltage at low cost which can treat waste water effectively according to characteristics of a contaminant and has no fear of secondary contamination.

### CROSS-REFERENCE TO RELATED APPLICATION

This application claims priority from Korean Patent Application No. 10-2010-0052633, filed on Jun. 4, 2010 in the Korean Intellectual Property Office, the disclosure of which is incorporated herein by reference.

### BACKGROUND

1. Field

The present invention relates to an apparatus for generating high frequency electromagnetic field and water purification system comprising the same.

2. Description of the Related Art

Commonly, the technology of wastewater treatment is divided into a biological process, a chemical process and a physical process and so on. Moreover, it can be divided into the first, the second, third process and so on. The first process is the physical process and the second process is the chemical or biological process. And the high class of third process can be any one out of the physical, chemical and biological process.

An advanced oxidation method is spotlighted as high class of a method of waste water treatment these days. This method, one of the typical physical process, is to treat contaminants in waste water using oxidation-reduction reaction.

Although, the typical method of waste water treatment using the advanced oxidation method has complex structure of the apparatus, but the process corresponding to the type and characteristics of contaminants is invariable and uniform. Therefore, it is not effective despite of high cost.

Furthermore, there is concern about increasing non-degradability as the contaminants, degraded in supersonic waves, recombined in some range of high-frequency waves.

Therefore, what is needed is some type of apparatus which has no risk of occurrence of secondary contaminants and has good efficiency to treat wastewater with reasonable cost.

### SUMMARY

Objects of the present invention are to provide an apparatus for generating high frequency electromagnetic field which is capable of adjusting a magnetic field intensity and frequency having direct influence on degradability according to the characteristics of contaminant, and to provide a water purification system having thereof.

The other object of the present invention is to provide an apparatus for generating high frequency electromagnetic field which has no risk of occurrence of the second contamination, and a water purification system having thereof with reasonable cost.

The objects can be attained by an apparatus comprising a user input unit; a quantum field generator for generating a high-voltage quantum field which is capable of adjusting output voltage; a wave generator for generating high-frequency signals with variable waveforms and matching the high-frequency signals with the quantum field generator; a high-frequency output unit for scanning the matched high-frequency quantum field; and a controller that controls level of the output voltage from the quantum field generator and output frequency from the wave generator corresponding to input by the user input unit.

Wherein the user input unit comprises selecting means which is capable of selecting a type of a contaminant; the controller saves data about level of the output voltage and the output frequency of the high-frequency signals corresponding to characteristics of the contaminant in advance, and outputs a control signal to the quantum field generator and the wave generator by reading data corresponding to input by the user input unit.

Also, wherein the quantum field generator comprises a primary power supply; a variable voltage generator varying the voltage that is generated by the primary power supply according to the control signal of the controller and outputting the varied voltage; a high-voltage conversion unit converting the varied voltage into high voltage; and a voltage multiplying rectifier circuit unit generating required quantum field by rectifying and multiplying the varied high voltage.

Furthermore, wherein the variable voltage generator varies and outputs voltage in the range of AC 0 to 220V using a slide transformer, the high-voltage conversion unit varies and outputs voltage in the range of 0 to 10 kV, and the voltage multiplying rectifier circuit unit varies and outputs voltage in the range of 0 to 40 kV.

Moreover, wherein the wave generator is comprised of a secondary power supply; a high-frequency variable generator adjusting frequency according to the control signal of controller and outputting a high-frequency signal, a wave amplifier amplifying the high-frequency signal outputted by high-frequency variable generator, and a matching unit matching the high-frequency signal output from wave amplifier with a voltage multiplying rectifier circuit unit.

Likewise, the matching unit is formed by connecting with a high withstand-voltage resistance and a condenser in parallel and linking a diode to output unit, and the high-frequency variable generator varies and outputs high-frequency signal in the range of 16 KHz to 40 MHz.

Furthermore, water purification system comprising the apparatus mentioned above further comprising a high-frequency discharge electrode discharging high-frequency quantum field; a protective cap to protect high-frequency discharge electrode; and a reactor comprised of a diffuser for air bubbling which is capable of bubbling discharged high-frequency quantum field from high-frequency discharge electrode into waste water and an earth electrode.

### BRIEF DESCRIPTION OF THE DRAWINGS

FIG. 1 is a block diagram showing an apparatus for generating high frequency electromagnetic field according to an embodiment of the present invention;

FIG. 2 is a block diagram showing a quantum field generator, a wave generator, and a high-frequency output unit according to an embodiment of the present invention;

FIG. 3 is a detailed circuit diagram of FIG. 2; and

FIG. 4 is a schematic view of a water purification system comprising the apparatus for generating high frequency electromagnetic field shown in FIG. 1 according to an embodiment of the present invention.

### DETAILED DESCRIPTION OF EXEMPLARY EMBODIMENTS

Reference will now be made in detail to the presently preferred embodiments of the invention as illustrated in the accompanying drawing.

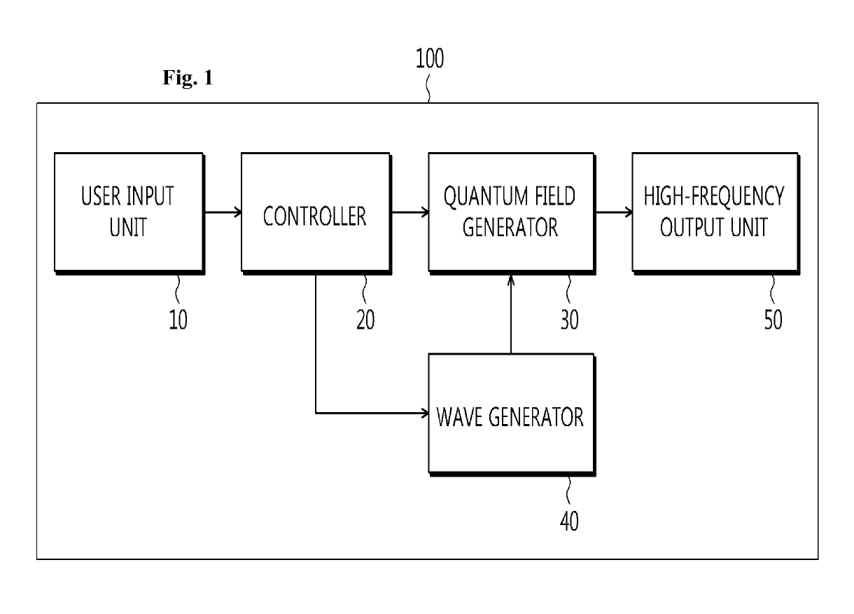

FIG. 1 is a block diagram showing an apparatus for generating high frequency electromagnetic field according to an embodiment of the present invention.

As schematically shown in FIG. 1 the apparatus for generating high frequency electromagnetic field 100 comprises a user input unit 10, a controller 20, a quantum field generator 30, a wave generator 40 and a high-frequency output unit 50.

The user input unit 10 is to receive input from users, having user interface that the user can input or select output voltage of the quantum field generator 30 and frequency of the wave generator 40.

The user input unit 10 can be constructed to allow the user to select the output voltage and the frequency of the quantum field directly. In another case, by setting predetermined voltage and frequency into multi levels, the user input unit 10 can be constructed to allow the user to select the level among the multi levels which the user wants. Furthermore, it also can be constructed to allow the user to select types of contaminants.

The controller 20 controls the level of the output voltage and the output frequency of a high-frequency electromagnetic field generator 100 by outputting the control signal to the quantum field generator 30 and the wave generator 40 mentioned below according to the input from the user input unit 10.

When the user input unit 10 has the multi level for selection of the output voltage and frequency, the controller 20 saves control values corresponding to the multi level. The control values are used to control the quantum field generator 30 and the wave generator 40 In another case, the controller saves the values of wave frequency and voltage level in advance, which have good efficiency for purifying contaminants in accordance with types and characteristics of contaminants. The controller 20 controls the quantum field generator 30 and the wave generator 40 to output the wave frequency and the voltage corresponding to the contaminants selected by the user input unit 10.

The quantum field generator 30 which is to generate high-voltage quantum field, is constructed to adjust the output voltage by control of controller 20.

The wave generator 40, which is to generate high-frequency signals and connect those to the quantum field generator 30, is constructed to adjust the frequency by control of controller 20.

The matched high-voltage quantum field with high frequency is scanned by the high-frequency output unit 50.

As explained above, this present invention is able to respond appropriately to the types and characteristics of contaminants by outputting quantum and waves being suitable for primary contaminants corresponding to the selection of the user.

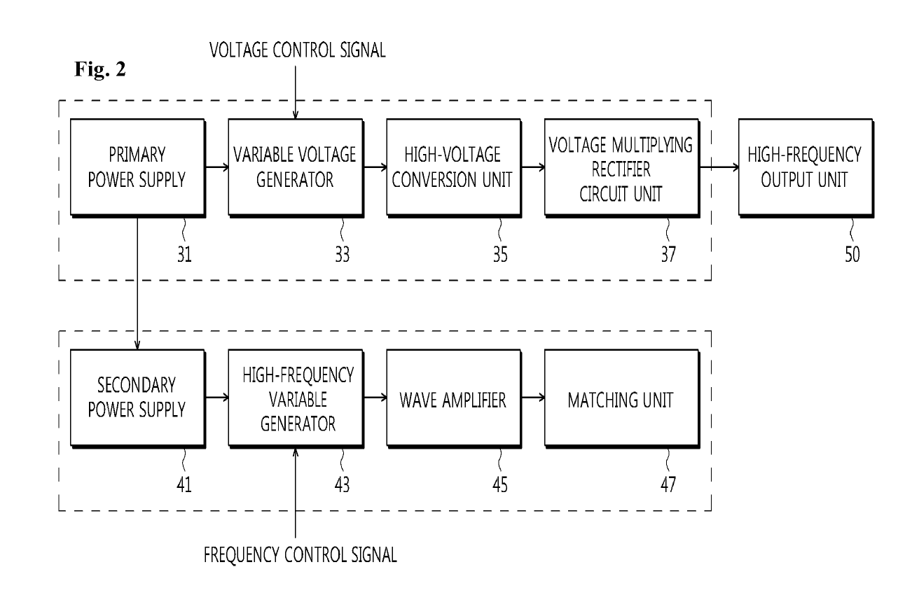

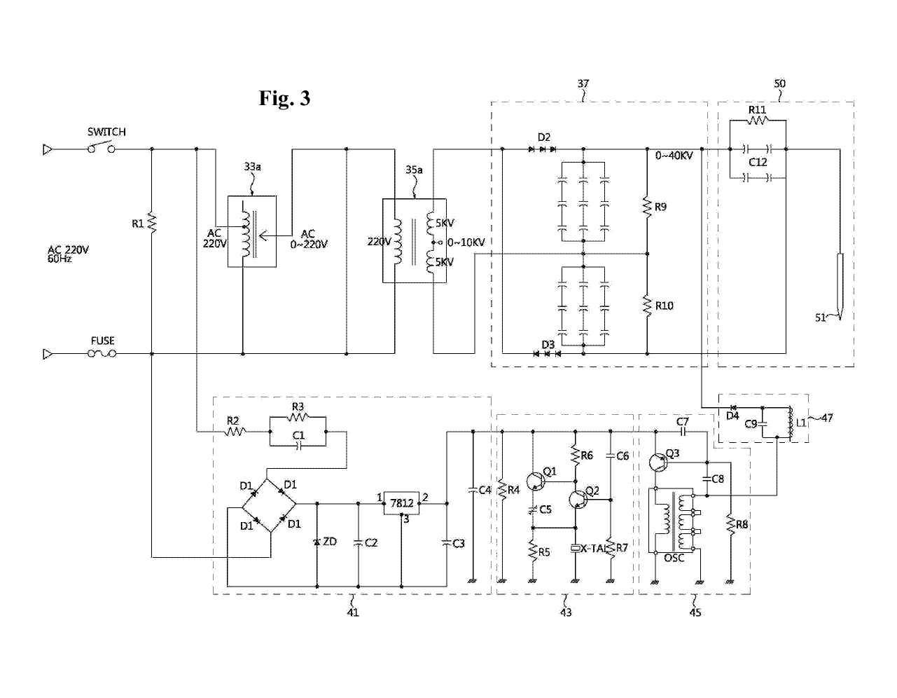

FIG. 2 is a block diagram showing a quantum field generator 30, a wave generator 40 and a high-frequency output unit 50 according to an embodiment of the present invention. FIG. 3 is a detailed circuit diagram of FIG. 2.

As schematically shown in FIG. 2, the quantum field generator 30 comprises a primary power supply 31, a variable voltage generator 33, a high-voltage conversion unit 35, and a voltage multiplying rectifier circuit unit 37.

The primary power supply 31 usually uses commercial power AC 220V, 60 Hz to apply power to the quantum field generator 30. As shown in FIG. 3, a switch is connected with fuse, just in case of short-circuit in the secondary power supply and output unit.

The variable voltage generator 33 is to adjust the second voltage, varying output voltage in the range of 0V to 220V, according to control of the controller 20 described hereafter. As shown in FIG. 3, the variable voltage generator 33 can be constructed by using slide transformer 33a which has small capacity considering that the second voltage is extra high voltage.

The high-voltage conversion unit 35 is to convert low output voltage of the variable voltage generator 33 to extra-high voltage. As shown in FIG. 3, Having the transformer 35a, the primary voltage 220V is boosted to the second voltage 10 Kv. The second voltage is variable adjusted 0 to 10 kV continuously by voltage of the first slide transformer.

The level of the second voltage, working directly on intensity of magnetic field, is able to be various values, but in this embodiment it is fixed on 10 kV considering insulation and safety.

The continuously variable of the second voltage is essential for the optimized output. The capacity of the transformer for boosting is decided by required intensity of the magnetic field.

The voltage multiplying rectifier circuit unit 37 is to generate extra-high electromagnetic field by rectifying and multiplying the voltage. As shown in FIG. 3, the voltage multiplying rectifier 37 is designed to multiply output voltage reaching 40 kV by using quadruple voltage rectification method with condensers and switching diodes having high voltage and high speed. The output voltage in the range of 0 to 40 kV is generated by adjusting the first slide transformer.

In this embodiment, Zener diodes are applied for the protection of circuit. The current flows suddenly when the voltage reversed to PN-junction is applied to diodes. Zener effect is to occur tunneling effect of quantum mechanics that electrons in p-type semiconductor pass through small holes of insulated regions as reverse voltage gets higher. The higher reverse voltage is applied, the wider tunnel will be. Therefore, the current increases, but the voltage remains unchanged. In summary, The Zener diode is a device to make constant voltage using the phenomenon that the voltage remains unchanged mentioned above.

The condenser of the voltage multiplying rectifier circuit unit 37 has characteristics that electrical charges are charged when DC current is applied, and the electrical charges are discharged when it connected with circuit having reversed voltage to that charged voltage. As these steps are repeated rapidly, AC current caused by the charging and discharging flows at both ends of the condenser.

The extra-high quantum field is generated at the quantum field generator 30 through these steps.

The wave generator 40 generates variable high-frequency signals and connects those signals to the quantum generator 30, which is explained with FIG. 2 and FIG. 3 hereafter.

As shown in FIG. 2, the wave generator 40 comprises a secondary power supply 41, a high-frequency variable generator 43, a wave amplifier 45, and a matching unit 47.

The primary power supply 31 supplies power the secondary power supply 41. The secondary power supply 41 converts the power applied from the primary power supply 31 into DC power and supplies the DC power to the high-frequency variable generator 43 and the wave amplifier As shown in FIG. 3, two constant-current diodes and two constant-voltage diodes is designed to the Darlington circuit having low-voltage FET and the control transistor. Rectifying commercial power of AC 220V, the circuit converts AC 220V into DC 12V. Thus, the circuit uses this converted DC power in the range of limited current capacity.

The high-frequency variable generator 43 is to generate high-frequency signals by adjusting the frequency according to the control of the controller 20 described hereafter. As shown in FIG. 3, the high-frequency variable generator 43 oscillates high frequency in the range of 16 KHz to 40 MHz using UJT (Unijunction Transistor) and IC (Ingrated Circuit) for high frequency.

The UJT has a little amount of leakage current and low saturation voltage. Moreover, the UJT is stable to temperature change. Therefore, the oscillation circuit comprising the UJT operates stably.

The high-frequency variable generator 43 changes the frequency, varying values of resistances and capacity of condensers connected to the circuit shown in FIG. 3. In this embodiment, the values of resistances and capacity of condensers are adjusted at the same ratio for stable oscillation, and the variable resistances and variable condensers are used.

The wave amplifier 45 is to amplify high-frequency signals outputted from the high-frequency variable generator 43. As shown in FIG. 3, the wave amplifier 45 amplifies the high-frequency signals using high-speed switching transistor and OSC (Oscilloscope). In embodiment of FIG. 3, the oscillation frequency is in the range of 16 KHz to 40 MHz. The frequency is used to 30 MHz for efficiency and stability of the amplified frequency amplitude.

The matching unit 47 is to connect the high-frequency waves from the wave amplifier 45 with the quantum field generator 30. As shown in FIG. 3 the matching unit is composed of high withstand-voltage resistances, high-frequency condensers and high-frequency diodes, which are combined in series or parallel to protect from insulation.

The high-frequency output unit 50 outputs the high-frequency quantum field of extra high voltage which is matched by the matching unit 47. As shown in FIG. 3, the high-frequency output unit 50 comprises a high-frequency discharge electrode discharging the high-frequency quantum field. The high-frequency output unit 50 can be constructed with supermalloy to scan the high-frequency magnetic field with maximum output voltage of 40 KV and 30 MHz. The supermalloy, which is an alloy added Cr to the alloy of Fe and Ni, has high magnetic susceptibility, small coercive force, small Hysteresis loss and small eddy current.

As explained above, this present invention has good efficiency for purifying water, controlling the output voltage of the quantum field generator 30 and output frequency of the wave generator 40 according to contaminants by the input of the user input unit 10.

For instance, an experiment shows a result that the efficiency is highest when the quantum field of 22KV, 1.64 MHz is scanned to wastewater including lots of non-biodegradable compounds of textile wastewater (Soluble Chemical Oxygen Demand increases 1.14 times and non-degradable materials are dualized). The another experiment shows a result that the efficiency is highest when the quantum field of 24KV, 1.64 MHz is scanned to wastewater including lots of non-biodegradable organic compounds of domestic wastewater(Soluble Chemical Oxygen Demand increases 2.25 times and non-degradable materials, which are difficult to degrade biologically, are dualized).

The controller 20 can make the quality of purifying wastewater high by saving proper control values in advance in accordance with types and characteristics of contaminants.

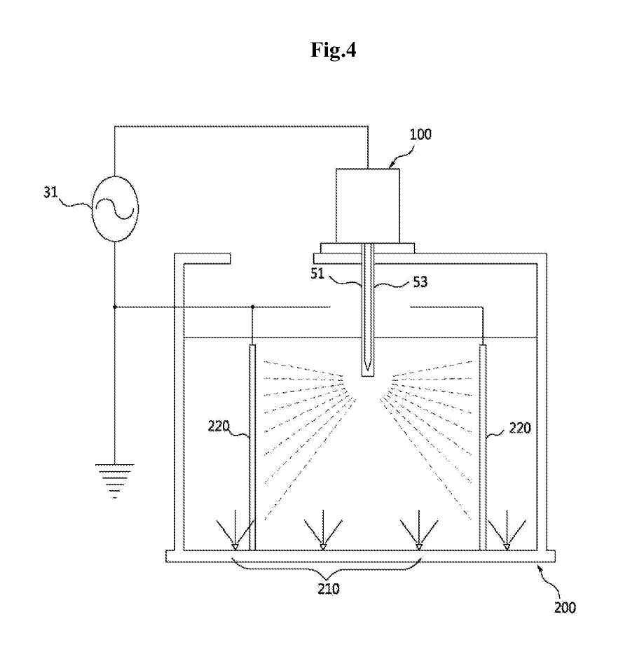

FIG. 4 is a schematic view of a water purification system comprising the apparatus for generating high frequency electromagnetic field 100 mentioned above.

As shown in FIG. 4, the water purification system comprises the apparatus for generating high frequency electromagnetic field 100 and a reactor 200.

The reactor 200 comprises a diffuser for air bubbling 210 and an earth electrode 220. The high-frequency discharge electrode 51 comprises a protective cap 53.

When the apparatus for generating high frequency electromagnetic field 100 scans the extra high-frequency electromagnetic field which is suitable for contaminants and having range of 1 KHz to 400 MHz and the diffuser 210 bubbles airs in wastewater including various kinds of non-biodegradable compounds, anions and cations are dissociated, maintaining an eletro-equilibrium.

Therefore, hydrated organic compounds and complex ions of heavy metals are separated from hydration layer, and gas like reaction occurs in the water by these compounds and ions. In this condition, dissociation and ionization of contaminants are accelerated when polar organic molecules are escaped from the hydration layer by aeration using external underwater fan. It is because organic matters, complex ions, anions and cations are activated to higher energy level as V.O.C is oxidized and decomposed in the air in an instant.

Furthermore, the organic combined insoluble Phosphorus which is difficult to be decomposed is mineralized into ortho form and transforming soluble sludge, it makes easier to treat. Moreover, the water purification system nitrifies by converting Nitrogen to Proteins, and emits in the form of gas.

This present invention activates dissociation and ionization of contaminants by varying frequency and voltage to be suitable for contaminants to adjust quantum field intensity.

As mentioned above, the present invention is to provide the apparatus with reasonable cost which has good efficiency for treatment of wastewater according to characteristics of contaminants and has no risk of occurrence of the secondary contamination, and to also provide the system having thereof. Although a few exemplary embodiments have been shown and described, it will be appreciated by those skilled in the art that changes may be made in these exemplary embodiments without departing from the principles and spirit of the invention, the scope of which is defined in the appended claims and their equivalents.

What is claimed is:

1. An apparatus for generating high-frequency electromagnetic field with adjustable magnetic field intensity and waveform comprising:
a user input unit;
a quantum field generator for generating a high-voltage quantum field which is capable of adjusting output voltage;
a wave generator for generating high-frequency signals with variable waveforms and matching the high-frequency signals with the quantum field generator;
a high-frequency output unit for scanning the matched high-frequency quantum field; and
a controller that controls level of the output voltage from the quantum field generator and output frequency from the wave generator corresponding to input by the user input unit.

2. An apparatus of claim 1, wherein the user input unit comprises selecting means which is capable of selecting a type of a contaminant, and
the controller saves data about level of the output voltage and the output frequency of the high-frequency signals corresponding to characteristics of the contaminant in advance, and outputs a control signal to the quantum field generator and the wave generator by reading data corresponding to input by the user input unit.

3. An apparatus of claim 1, wherein the quantum field generator comprises a primary power supply;
a variable voltage generator varying the voltage that is generated by the primary power supply according to the control signal of the controller and outputting the varied voltage;
a high-voltage conversion unit converting the varied voltage into high voltage; and
a voltage multiplying rectifier circuit unit generating required quantum field by rectifying and multiplying the varied high voltage.

4. An apparatus of claim 3, wherein the variable voltage generator varies and outputs voltage in the range of AC 0 to 220V using a slide transformer,
the high-voltage conversion unit varies and outputs voltage in the range of 0 to 10 kV, and
the voltage multiplying rectifier circuit unit varies and outputs voltage in the range of 0 to 40 kV.

5. An apparatus of claim 3, wherein the wave generator comprises a secondary power supply,
a high-frequency variable generator adjusting frequency according to the control signal of controller and outputting a high-frequency signal,
a wave amplifier amplifying the high-frequency signal outputted by high-frequency variable generator, and
a matching unit matching the high-frequency signal outputted by wave amplifier with a voltage multiplying rectifier circuit unit.

6. An apparatus of claim 5, wherein the matching unit is formed by to connect with a high withstand-voltage resistance and a condenser in parallel and to link a diode to output unit.

7. An apparatus of claim 5, wherein the high-frequency variable generator varies and outputs high-frequency signal in the range of 16 KHz to 40 MHz

8. A water purification system comprising:
an apparatus of claim 1 further comprising a high-frequency discharge electrode discharging high-frequency quantum field;
a protective cap to protect high-frequency discharge electrode; and
a reactor comprised of a diffuser for air bubbling which is capable of bubbling discharged high-frequency quantum field from high-frequency discharge electrode into waste water and an earth electrode.

9. A water purification system comprising:
an apparatus of claim 2 further comprising a high-frequency discharge electrode discharging high-frequency quantum field;
a protective cap to protect high-frequency discharge electrode; and
a reactor comprised of a diffuser for air bubbling which is capable of bubbling discharged high-frequency quantum field from high-frequency discharge electrode into waste water and an earth electrode.

10. A water purification system comprising:
an apparatus of claim 3 further comprising a high-frequency discharge electrode discharging high-frequency quantum field;
a protective cap to protect high-frequency discharge electrode; and
a reactor comprised of a diffuser for air bubbling which is capable of bubbling discharged high-frequency quantum field from high-frequency discharge electrode into waste water and an earth electrode.

11. A water purification system comprising:
an apparatus of claim 4 further comprising a high-frequency discharge electrode discharging high-frequency quantum field;
a protective cap to protect high-frequency discharge electrode; and
a reactor comprised of a diffuser for air bubbling which is capable of bubbling discharged high-frequency quantum field from high-frequency discharge electrode into waste water and an earth electrode.

12. A water purification system comprising:
an apparatus of claim 5 further comprising a high-frequency discharge electrode discharging high-frequency quantum field;
a protective cap to protect high-frequency discharge electrode; and
a reactor comprised of a diffuser for air bubbling which is capable of bubbling discharged high-frequency quantum field from high-frequency discharge electrode into waste water and an earth electrode.

13. A water purification system comprising:
an apparatus of claim 6 further comprising a high-frequency discharge electrode discharging high-frequency quantum field;
a protective cap to protect high-frequency discharge electrode; and
a reactor comprised of a diffuser for air bubbling which is capable of bubbling discharged high-frequency quantum field from high-frequency discharge electrode into waste water and an earth electrode.

14. A water purification system comprising:
an apparatus of claim 7 further comprising a high-frequency discharge electrode discharging high-frequency quantum field;
a protective cap to protect high-frequency discharge electrode; and
a reactor comprised of a diffuser for air bubbling which is capable of bubbling discharged high-frequency quantum field from high-frequency discharge electrode into waste water and an earth electrode.
